(19) United States
(12) Patent Application Publication
(10) Pub. No.: US 2015/0186909 A1
(43) Pub. Date: Jul. 2, 2015

(54) METHOD AND SYSTEM FOR CONSUMER TRACKING USING GEOLOCATION

(71) Applicant: MasterCard International Incorporated, Purchase, NY (US)

(72) Inventors: Nikhil MALGATTI, Stamford, CT (US); Serge BERNARD, Danbury, CT (US); Kenny UNSER, Fairfield, CT (US)

(73) Assignee: MasterCard International Incorporated, Purchase, NY (US)

(21) Appl. No.: 14/141,978

(22) Filed: Dec. 27, 2013

(51) Int. Cl. G06Q 30/02

(52) U.S. Cl. CPC G06Q 30/0205

(57) ABSTRACT

A method for calculating consumer metrics includes: storing a plurality of transaction data entries, each entry including a transaction time and transaction geographic location associated with a transaction involving a consumer; receiving a plurality of location data entries, each entry including a consumer geographic location and a location time at which the consumer was at the location; identifying a first subset of location data entries, each entry in the first subset corresponding to a transaction data entry where the times and geographic locations correspond; identifying a second subset of location data entries, wherein the second subset includes each location data entry not in the first subset; calculating a consumer metric based on the location data entries and transaction data entries in the first subset and the location data entries in the second subset; and associating the calculated consumer metric with a consumer profile associated with the consumer.

### FIELD

The present disclosure relates to the calculation of consumer metrics based on geolocation data and transaction history, specifically the calculation of consumer analytics based on locations at which consumers visit and transact, as well as locations where a consumers visit, but do not transact.

### BACKGROUND

Merchants can often find significant value in data regarding consumer traffic at a physical storefront location. This data may help merchants select advertising, storefront decorations and displays, merchandise, offered services, and much more. It is often of interest to these merchants to obtain data regarding consumer traffic that is as accurate as possible. In an effort to capture this data, methods and systems have been designed to measure consumer traffic in an out of a store. However, such methods and systems typically identify consumer traffic into and out of the store without regard to identification of the consumers themselves. As a result, such systems may be unable to identify if consumers that visit the store conduct transactions at the store, or leave without making a purchase.

Some methods and systems have been developed for analyzing transaction data for transactions that take place at a merchant location. When combined with consumer traffic data, this may enable a merchant to identify trends among consumers that visit the store based on the transactions that are conducted. However, the lack of specificity as to each consumer may result in a wealth of data that is not captured. For example, the merchant may be unable to identify the shopping habits of repeat consumers as opposed to one-time consumers, may be unable to identify consumers that visited and did not purchase, went elsewhere, and then return to make a purchase when unable to do so at a competitor, etc. Furthermore, such systems and methods also fail to account for consumer traffic and behavior at other merchants, which may provide even greater depth to captured data.

Thus, there is a need for a technical solution to calculate consumer metrics for consumers based on locations visited by consumers where they engaged in transactions, as well as locations visited by the consumers where they did not engage in transactions.

### SUMMARY

The present disclosure provides a description of systems and methods for the calculation of consumer metrics.

A method for calculating consumer metrics includes: storing, in a transaction database, a plurality of transaction data entries, wherein each transaction data entry includes data related to a payment transaction involving a consumer including at least transaction data, a transaction time and/or date, and a transaction geographic location associated with the related payment transaction; receiving, by a receiving device, a plurality of location data entries, wherein each location data entry includes data related to a location of the consumer including at least a consumer geographic location and a location time and/or date at which the consumer was identified at the consumer geographic location; identifying, by a processing device, a first subset of the plurality of location data entries, wherein each location data entry in the first subset corresponds to a transaction data entry stored in the transaction database where the included transaction time and/or date and transaction geographic location correspond to the location time and/or date and consumer geographic location included in the respective location data entry; identifying, by the processing device, a second subset of the plurality of location data entries, wherein the second subset includes each location data entry not included in the first subset of the plurality of location data entries; calculating, by the processing device, at least one consumer metric based on the location data entries and corresponding transaction data entries included in the first subset of the plurality of location data entries and the location data entries included in the second subset of the plurality of location data entries; and associating the calculated at least one consumer metric with a consumer profile associated with the consumer.

Another method for calculating consumer metrics includes: storing, in a transaction database, a plurality of transaction data entries, wherein each transaction data entry includes data related to a payment transaction including at least transaction data, a transaction time and/or date, and a transaction geographic location associated with the related payment transaction; storing, in a location database, a plurality of location data entries, wherein each location data entry includes data related to a location of a consumer including at least a consumer geographic location and a location time and/or date at which the consumer was identified at the consumer geographic location; receiving, by a receiving device, a metric request, wherein the metric request includes at least a specific geographic location, a predetermined period of time, and at least one metric; identifying, in the transaction database, a subset of the plurality of transaction data entries where the transaction geographic location and the transaction time and/or date included in each transaction data entry corresponds to the specific geographic location and predetermined period of time included in the received metric request; identifying, in the location database, a subset of the plurality of location data entries where the consumer geographic location and the location time and/or date included in each location data entry corresponds to the specific geographic location and predetermined period of time included in the received metric request; calculating, by a processing device, the at least one metric included in the received metric request based on at least the identified subset of the plurality of transaction data entries and the identified subset of the plurality of location data entries; and transmitting, by a transmitting device, the calculated at least one metric in response to the received metric request.

A system for calculating consumer metrics includes a transaction database, a receiving device, and a processing device. The transaction database is configured to store a plurality of transaction data entries, wherein each transaction data entry includes data related to a payment transaction involving a consumer including at least transaction data, a transaction time and/or date, and a transaction geographic location associated with the related payment transaction. The receiving device is configured to receive a plurality of location data entries, wherein each location data entry includes data related to a location of the consumer including at least a consumer geographic location and a location time and/or date at which the consumer was identified at the consumer geographic location. The processing device is configured to: identify a first subset of the plurality of location data entries, wherein each location data entry in the first subset corresponds to a transaction data entry stored in the transaction database where the included transaction time and/or date and transaction geographic location correspond to the location time and/or date and consumer geographic location included in the respective location data entry; identify a second subset of the plurality of location data entries, wherein the second subset includes each location data entry not included in the first subset of the plurality of location data entries; calculate at least one consumer metric based on the location data entries and corresponding transaction data entries included in the first subset of the plurality of location data entries and the location data entries included in the second subset of the plurality of location data entries; and associate the calculated at least one consumer metric with a consumer profile associated with the consumer.

Another system for calculating consumer metrics includes a transaction database, a location database, a receiving device, a processing device, and a transmitting device. The transaction database is configured to store a plurality of transaction data entries, wherein each transaction data entry includes data related to a payment transaction including at least transaction data, a transaction time and/or date, and a transaction geographic location associated with the related payment transaction. The location database is configured to store a plurality of location data entries, wherein each location data entry includes data related to a location of a consumer including at least a consumer geographic location and a location time and/or date at which the consumer was identified at the consumer geographic location. The receiving device is configured to receive a metric request, wherein the metric request includes at least a specific geographic location, a predetermined period of time, and at least one metric. The processing device is configured to: identify, in the transaction database, a subset of the plurality of transaction data entries where the transaction geographic location and the transaction time and/or date included in each transaction data entry corresponds to the specific geographic location and predetermined period of time included in the received metric request; identify, in the location database, a subset of the plurality of location data entries where the consumer geographic location and the location time and/or date included in each location data entry corresponds to the specific geographic location and predetermined period of time included in the received metric request; and calculate the at least one metric included in the received metric request based on at least the identified subset of the plurality of transaction data entries and the identified subset of the plurality of location data entries. The transmitting device is configured to transmit the calculated at least one metric in response to the received metric request.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for the calculation of consumer metrics based on geolocation and transaction data in accordance with exemplary embodiments.

FIG. 2 is a block diagram illustrating the processing server of FIG. 1 for the calculation of consumer metrics in accordance with exemplary embodiments.

FIG. 3 is a flow diagram illustrating a method for the calculation of consumer metrics for a consumer based on geolocation and transaction data in accordance with exemplary embodiments.

FIG. 4 is a flow diagram illustrating a method for the calculation of consumer metrics for a geographic location based on geolocation and transaction data in accordance with exemplary embodiments.

FIG. 5 is a diagram illustrating correspondence between consumer geolocation data and transaction data in accordance with exemplary embodiments.

FIG. 6 is a diagram illustrating correspondence between merchant consumer data and transaction data in accordance with exemplary embodiments.

FIGS. 7 and 8 are flow charts illustrating exemplary methods for calculating consumer metrics in accordance with exemplary embodiments.

FIG. 9 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

### System for the Calculation of Consumer Metrics

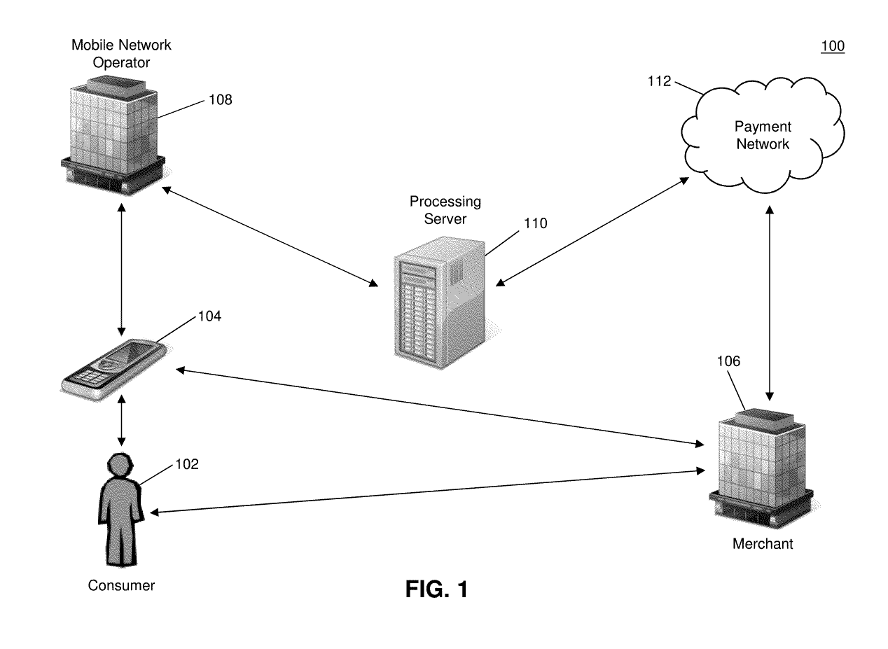

FIG. 1 illustrates a system 100 for the calculation of consumer metrics for one or more consumers at one or more merchants based on consumer geolocation data and transaction data.

The system 100 may include a consumer 102. The consumer 102 may possess a mobile computing device 104. The mobile computing device 104 may be configured to communicate with a mobile network operator 108 via a mobile network operated and/or maintained by the mobile network operator 108. The mobile network operator 108 may be configured to identify a geographic location of the mobile computing device 104 using methods and systems as will be apparent to persons having skill in the relevant art, such as the global positioning system, cellular network triangulation, and Wi-Fi network detection.

The mobile network operator 108 may be configured to provide location data for the mobile computing device 104 associated with the consumer 102 to a processing server 110. The processing server 110, discussed in more detail below, may store the location data in one or more databases, such as the consumer database and location database, also discussed in more detail below. It will be apparent to persons having skill in the relevant art that additional methods and systems may be used to identify location data associated with the consumer 102. For example, the location of a vehicle associated with the consumer 102 may be identify, such as using systems and methods illustrated in U.S. patent application Ser. No. 14/087,994, entitled “Method and System for Integrating Vehicle Data with Transaction Data” by Nikhil Malgatti, et al., filed on Nov. 22, 2013, which is herein incorporated by reference in its entirety.

The consumer 102 may visit a merchant 106. The mobile network operator 108 may identify a geographic location of the mobile computing device 104 as being located at the merchant 106, and then may transmit the geographic location to the processing server 110. In some embodiments, the mobile network operator 108 may transmit the geographic location itself to the processing server 110, such as a location represented by latitude and longitude, a street address, zip code or postal code, etc. In other embodiments, the mobile network operator 108 may identify the location of the mobile computing device 104 as associated with the merchant 106 and may thus transmit the merchant 106 to the processing server 110 as the geographic location of the consumer 102. In embodiments where the location is provided to the processing server 110 without association with a merchant 106, the processing server 110 may identify the merchant 106 associated with the received geographic location using methods and systems that will be apparent to persons having skill in the relevant art.

In some instances, the consumer 102 may not conduct a payment transaction with the merchant 106 after visiting. In other instances, the consumer 102 may conduct a payment transaction with the merchant 106, which may be processed by a payment network 112. The payment network 112 may process the payment transaction and then may transmit transaction data associated with the payment transaction to the processing server 110. The processing server 110 may then store the transaction data in one or more transaction databases, as discussed in more detail below. In some instances, the processing server 110 may store the transaction data in a consumer profile associated with the consumer 102 involved in the payment transaction.

The transaction data may include at least a transaction time and/or date and a transaction geographic location. The transaction geographic location may be included in an authorization request associated with the payment transaction and may include a geographic location of the merchant 106, a point-of-sale device used to conduct the payment transaction, or the merchant 106 itself.

The processing server 110 may be configured to associate received transaction data for payment transactions involving the consumer 102 with location data corresponding to the consumer 102. For example, as discussed in more detail below, the processing server 110 may identify geographic locations where the consumer 102 visited a merchant 106 and engaged in a payment transaction, as well as geographic locations where the consumer 102 visited a merchant 106 but did not engage in a payment transaction. The processing server 110 may then calculate consumer metrics based on the geographic locations and on the associated transaction data where applicable, as discussed in more detail below.

By associating transaction data with location data, the processing server 110 may be able to identify locations visited by a consumer 102 where the consumer did not transact. This may further enable the processing server 110 to identify instances where the consumer 102 went on to transact at a different, competing merchant. This may identify instances of window shopping or pricing around by the consumer 102, and other tactics that may be valuable for identification by the merchant 106 or other third party. In addition, the processing server 110 may identify metrics for a particular merchant 106, including identifying consumers 102 that did transact at the merchant 106 as well as those that did not transact, including whether or not the consumers 102 that did not transact went elsewhere, purchased similar products via the Internet while at the store (e.g., using the mobile computing device 104), etc. Such data may be valuable to merchants 106, advertisers, content providers, and other third parties.

### Processing Server

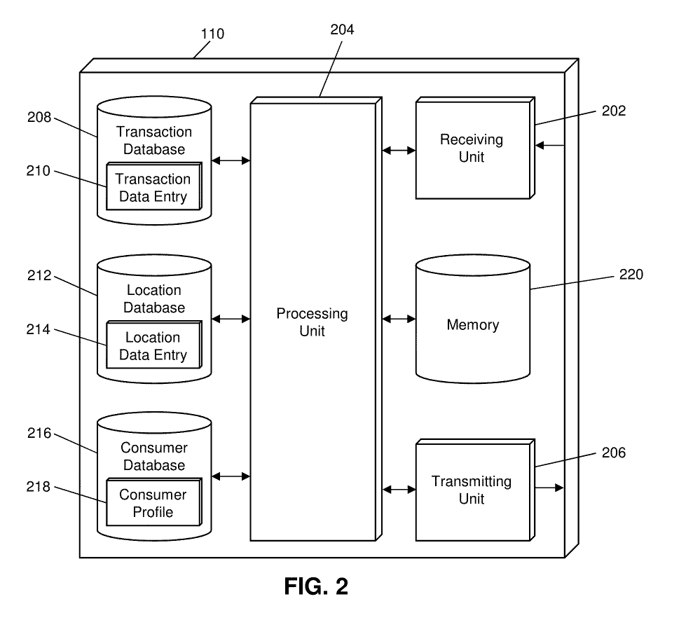

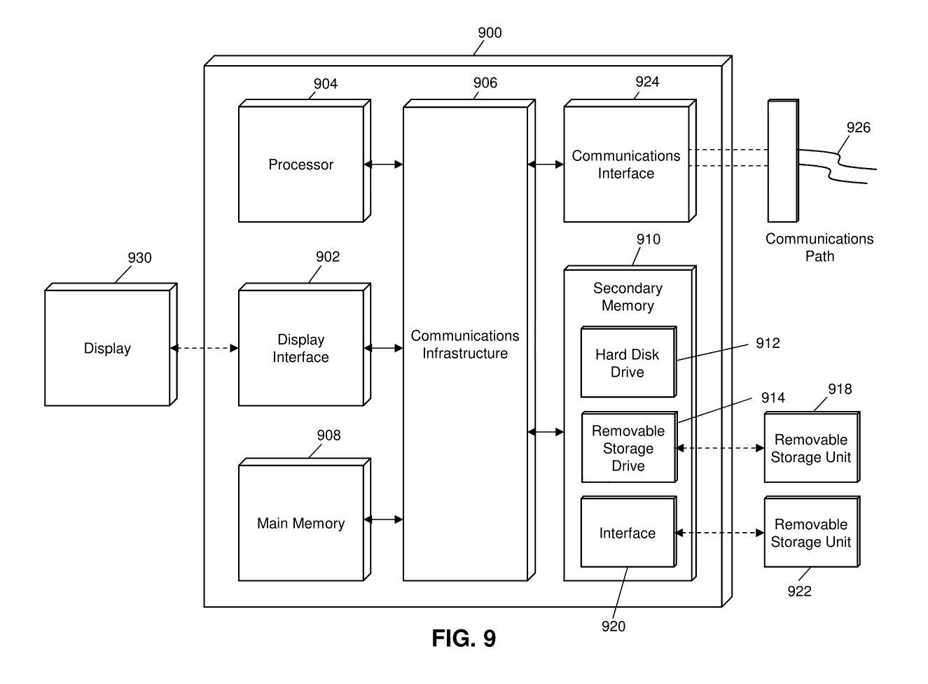

FIG. 2 illustrates an embodiment of the processing server 110 of the system 100. It will be apparent to persons having skill in the relevant art that the embodiment of the processing server 110 illustrated in FIG. 2 is provided as illustration only and may not be exhaustive to all possible configurations of the processing server 110 suitable for performing the functions as discussed herein. For example, the computer system 900 illustrated in FIG. 9 and discussed in more detail below may be a suitable configuration of the processing server 110.

The processing server 110 may include a receiving unit 202. The receiving unit 202 may be configured to receive data over one or more networks via one or more network protocols. The receiving unit 202 may be configured to receive transaction data from the payment network 112 for a plurality of transactions involving one or more consumers 102. The processing server 110 may also include a processing unit 204, which may be configured to store the received transaction data in a transaction database 208 as a plurality of transaction data entries 210. Each transaction data entry 210 may store data related to a payment transaction including at least transaction data, a transaction time and/or date, and a transaction geographic location associated with the related transaction.

The transaction time and/or date may be the time and/or date at which the related payment transaction was conducted (e.g., authorized, processed, cleared, etc.). The transaction geographic location may be a geographic location of the merchant 106 and/or the point of sale device used to initiate and/or conduct the related payment transaction, such as included in an authorization request for the related payment transaction. In some instances, the processing unit 204 may be configured to identify (e.g., via a look-up table) the geographic location based on data included in the transaction data, such as a point of sale or merchant identifier. The transaction data may include any additional data that may be suitable for the calculation of consumer metrics based thereon, such as a transaction amount, merchant data, product data, etc. In some embodiments, transaction data entries 210 may further include a consumer identifier associated with a consumer 102 involved in the related payment transaction, as discussed below.

The receiving unit 202 may also be configured to receive location data from the mobile network operator 108 or other suitable entity or device (e.g., the mobile computing device 104). The processing unit 204 may be configured to store the received location data in a location database 212 as a plurality of location data entries 214. Each location data entry 214 may include data related to a location of a specific consumer 102 including at least a consumer geographic location and a location time and/or date at which the consumer 102 was identified at the consumer geographic location. In some embodiments, each location data entry 214 may further include a consumer identifier associated with the related consumer 102.

The consumer geographic location and the location time and/or date may be formatted and/or represented in any suitable method as will be apparent to persons having skill in the relevant art. For example, the consumer geographic location may be represented in latitude and longitude, as a street address, as a postal or zip code, etc. In some instances, the consumer geographic location and the location time and/or date may be formatted and/or represented in the same fashion as the transaction geographic location and transaction time and/or date included in each of the transaction data entries 210.

The processing server 110 may further include a consumer database 216. The consumer database 216 may be configured to store a plurality of consumer profiles 218. Each consumer profile 218 may include data related to a consumer 102. The consumer profile 218 may include transaction data entries 210 and/or location data entries 214 associated with the related consumer 102, such as identified via a consumer identifier associated with the consumer 102 and included in the consumer profile.

For example, the processing unit 204 may identify those transaction data entries 210 whose transaction data includes a specific consumer identifier and those location data entries 214 including the specific consumer identifier, and store the data in a consumer profile 218 including or associated with the specific consumer identifier. The consumer identifier may be a unique value suitable for the identification of a consumer profile 218. The consumer identifier may be a payment account number, username, e-mail address, phone number, identification number, or any other suitable value as will be apparent to persons having skill in the relevant art.

The processing unit 204 may be further configured to identify consumer metrics associated with a consumer 102 based on the transaction data entries 210 and location data entries 214 included in the consumer profile 218 associated with the consumer 102. The consumer metrics may be identified based on location data entries 214 for consumer geographic locations corresponding to merchants 106 where the consumer 102 did not conduct payment transactions, as well as location data entries 214 for consumer geographic locations corresponding to merchants 106 where the consumer did conduct payment transactions using the transaction data entries 210. Methods for identifying correspondence between the transaction data entries 210 and location data entries 214, and the identification of consumer metrics based thereon, are discussed in more detail below.

The processing unit 204 may be configured to associate the identified consumer metrics in the consumer profile 218 associated with the consumer 102 for whom the metrics were calculated. In some embodiments, the metrics may be based on one or more rules or algorithms, which may be stored in a memory 220. The memory 220 may be configured to store the rules or algorithms, and any additional data that may be necessary for the processing unit 204 to perform the functions as disclosed herein as will be apparent to persons having skill in the relevant art.

The processing server 110 may further include a transmitting unit 206. The transmitting unit 206 may be configured to transmit data over one or more networks via one or more network protocols. In some instances, the transmitting unit 206 may be configured to transmit calculated consumer metrics (e.g., associated with a consumer profile 218) to a third party, such as the merchant 106, an advertiser, etc. In some embodiments, the calculated consumer metrics may be transmitted to a third party in response to a request for metrics received by the receiving unit 202. In such an embodiment, the request may identify specific metrics to be calculated, and the processing unit 204 may calculate the identified metrics that were requested for one or more consumer profiles 218.

In some instances, the request may identify a specific consumer 102 for whom consumer metrics are requested. In other instances, the request may be for a specific merchant 106 and/or a geographic location (e.g., associated with a specific merchant 106). In such an instances, the processing unit 204 may be configured to associate transaction data entries 210 involving the specific merchant 106 and/or geographic location (e.g., based on the included transaction data and/or transaction geographic location) with location data entries 214 based on the included times and/or dates and consumer identifiers. The processing unit 204 may then calculate consumer metrics based on the data, which may identify visiting consumers that did or did not transaction, may identify window shoppers, etc. Methods for identifying consumer metrics for consumers at a specific merchant 106 are discussed in more detail below.

### Process for Calculating Consumer Metrics for a Consumer

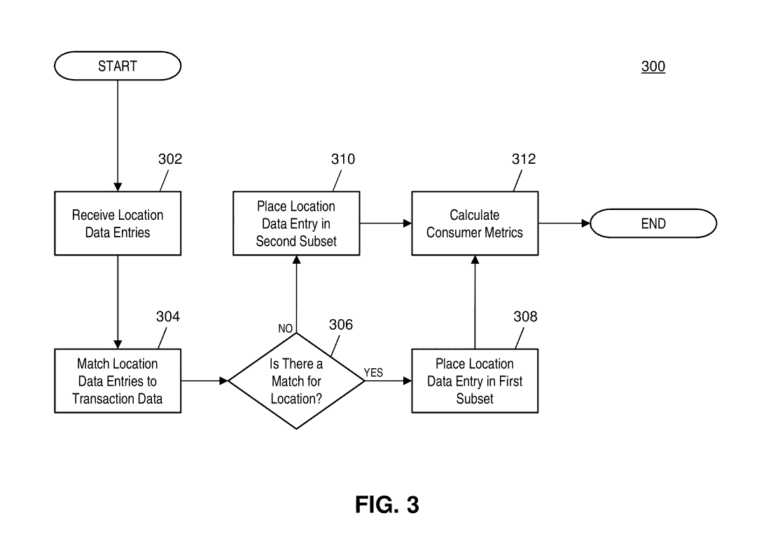

FIG. 3 illustrates a method 300 for the calculation of consumer metrics for a specific consumer 102 based on consumer location and transaction data.

In step 302, the receiving unit 202 of the processing server 110 may receive location data entries related to locations visited by the consumer 102 from the mobile network operator 108 or other suitable entity. The location data entries may include a consumer geographic location and a location time and/or date at which the consumer 102 was identified at the respective consumer geographic location. In some instances, the processing unit 204 of the processing server 110 may store the received location data entries in the location database 212, or in a consumer profile 218 associated with the consumer 102.

In step 304, the processing unit 204 may match the received location data entries to transaction data entries 210, which may be stored in the transaction database 208 and/or the consumer profile 218 associated with the consumer 102. For each location data entry 214, the processing unit 204 may determine, in step 306, if there is an associated transaction data entry 210. Associated transaction data entries 210 may be transaction data entries including a transaction geographic location that corresponds to the consumer geographic location with a transaction time and/or date that is at the same time, or within a predetermined period of time from, the location time and/or date.

If there is a successful match of a transaction data entry 210 for a received location data entry 214, then, in step 308, the location data entry 214 may be placed in a first subset of the location data entries. If there is no match for a transaction data entry 210, which may imply that the consumer 102 visited a merchant 106 and did not conduct a payment transaction, then, in step 310, the location data entry 214 may be placed in a second subset of location data entries.

Once each of the location data entries has been sorted into the first and second subsets, then, in step 312, the processing unit 204 may calculate consumer metrics for the associated consumer 102. The consumer metrics may be based on the location data entries included in each of the first and second subsets, as well as the transaction data entries 210 corresponding to the location data entries included in the first subset. The consumer metrics may include merchant preferences, location preferences, transaction behavior, location behavior, one or more propensities to transact, propensity to window shop, and other metrics as will be apparent to persons having skill in the relevant art.

### Process for Calculating Consumer Metrics for at a Merchant Location

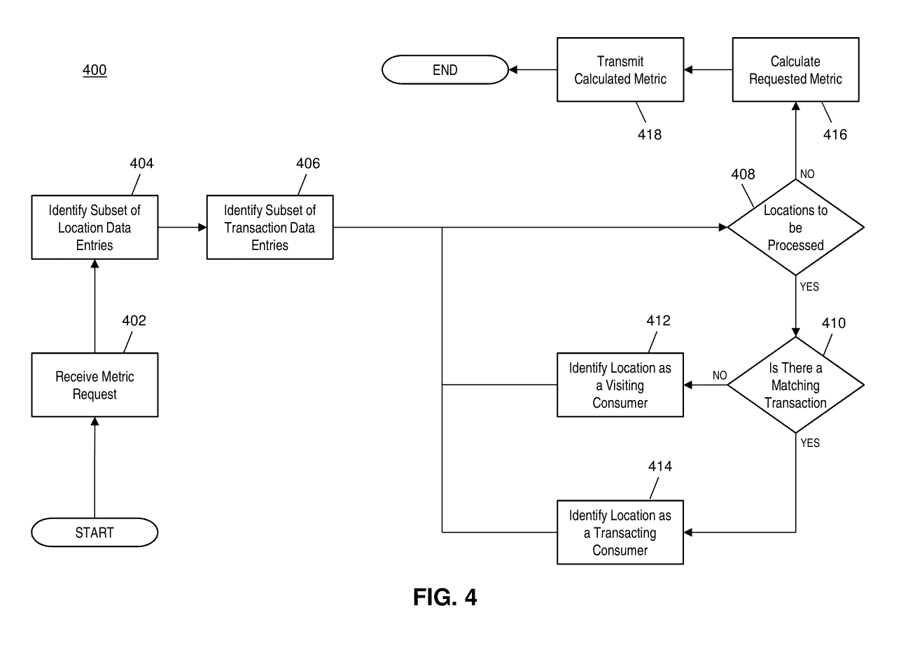

FIG. 4 illustrates a method 400 for the calculation of consumer metrics for consumers at a location of a merchant 106 based on consumer location and transaction data.

In step 402, the receiving unit 202 may receive a request for consumer metrics, such as from the merchant 106. The request for consumer metrics may include at least a specific geographic location (e.g., the geographic location of the merchant 106), a predetermined period of time for which the consumer metrics are requested (e.g., the prior month, the prior week, the holiday season, etc.), and at least one metric that is being requested. In step 404, the processing unit 204 may identify a subset of the plurality of location data entries 214 in the location database 212 where the included consumer geographic location corresponds to the specific geographic location and where the location time and/or date is within the predetermined period of time.

In step 406, the processing unit 204 may identify a subset of the plurality of transaction data entries 210 in the transaction database 208 where the included transaction geographic location corresponds to the specific geographic location and where the transaction time and/or date is within the predetermined period of time. The process 400 may then continue on for each location data entry 214 identified in the subset of location data entries. In step 408, the processing unit 204 may determine if there are remaining location data entries in the subset to be processed.

If there are remaining location data entries to be processed, then, in step 410, the processing unit 204 may determine if there is a matching transaction data entry 210 in the subset of transaction data entries for the next location data entry 214 to be processed. If there is no matching transaction data entry 210, then, in step 412, the processing unit 204 may identify the location data entry 214 as corresponding to a visiting consumer, which may be a consumer 102 that visited the merchant 106 without also conducting a payment transaction with the merchant 106. If there is a matching transaction data entry, then, in step 414, the processing unit 204 may identify the location data entry 214 as corresponding to a transacting consumer, which may be a consumer 102 that visited the merchant 106 and conducted a payment transaction with the merchant 106.

The process 400 may then return to step 408 to determine if there are still more location data entries 214 in the subset to be processed. Once all location data entries 214 in the subset have been processed (e.g., have been identified as being associated with visiting consumers or transacting consumers), then, in step 416, the processing unit 204 may calculate the metric as requested in the received metric request based on the location data entries 214 and associated transaction data entries 210 in the subsets corresponding to transacting consumers, and the location data entries 214 in the subset corresponding to visiting consumers.

In some instances, the consumer metrics calculated by the processing unit 204 for a specific geographic location may be different than metrics calculated for a specific consumer 102. For example, metrics for a merchant location may include transaction frequency, which may be unavailable for a single consumer 102. Additional metrics for a specific geographic location may include turnaround rate, visitor frequency, visitor statistics, transaction statistics, and other metrics as will be apparent to persons having skill in the relevant art. In step 418, the transmitting unit 206 of the processing server 110 may transmit the calculated metric to the requesting entity, in response to the received metric request.

### Correspondence Between Location and Transaction Data

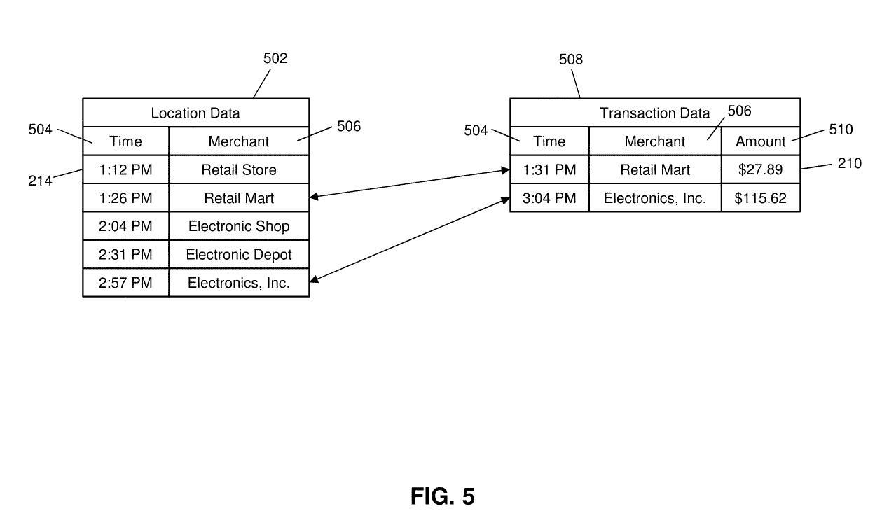

FIG. 5 is a diagram illustrating the correspondence between transaction data entries 210 of the transaction database 208 and location data entries 214 of the location database 212 for a specific consumer 102.

FIG. 5 includes a subset 502 of location data entries 214, which may include location data entries 214 of the location database 212 that are associated with a specific consumer 102. In some instances, the subset 502 may be stored in a consumer profile 218 associated with the specific consumer 102. Each location data entry 214 may include a geographic location 506, represented in FIG. 5 as a merchant name corresponding to the geographic location, and a time and/or date 504 at which the specific consumer 102 was at the geographic location. In the example illustrated in FIG. 5, the location data entries 214 are all for a single date, but it will be apparent to persons having skill in the relevant art that location data entries 214 across multiple days may be used.

FIG. 5 also includes a subset 508 of transaction data entries 210, which may include transaction data entries 210 of the transaction database 208 that are associated with the specific consumer 102, or may include transaction data entries 210 stored in the consumer profile 218 associated with the specific consumer 102. Each transaction data entry 210 may include the geographic location 506 where the specific consumer 102 transacted, the time and/or date 504 when the transaction was conducted, as well as transaction data for the corresponding payment transaction, such as a transaction amount 510.

As discussed above, the processing unit 204 may be configured to match location data entries 214 to transaction data entries 210 based on correspondence between the locations 506 and times 504. In the example illustrated in FIG. 5, the processing unit 204 may match two location data entries 214 to the transaction data entries 210 where the times 504 and locations 506 correspond. In the example, the consumer 102 visited five different merchants 106, but transacted at only two of them, the Retail Mart and Electronics, Inc. As discussed above, the processing unit 204 may thus place the two matched location data entries 214 in a first subset of the subset 502, and the three unmatched location data entries 214 in a second subset, for use in calculating metrics for the specific consumer 102.

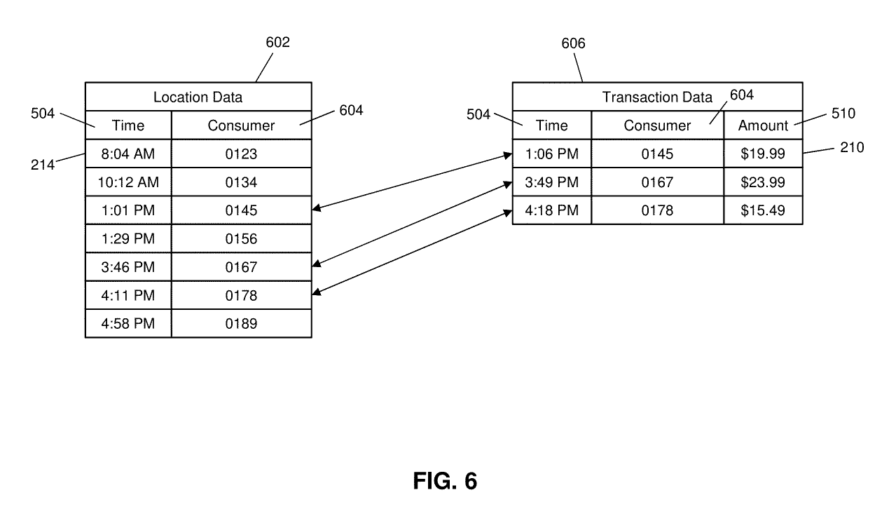

FIG. 6 illustrates the correspondence between transaction data entries 210 of the transaction database 208 and location data entries 214 of the location database 212 for consumers at a specific geographic location, such as a geographic location associated with the merchant 106.

A subset 602 may include location data entries 214 of the location database 212 corresponding to all consumer visits to the specific geographic location. Each of the location data entries 214 may include a time and/or date 504 when the respective consumer 102 visited and may also include a consumer identifier 604 associated with the corresponding consumer 102. A subset 606 may include transaction data entries 210 of the transaction database 208 corresponding to all consumer transactions conducted at the specific geographic location. Each of the transaction data entries 210 included in the subset 606 may include the time and/or date 504 when the corresponding transaction was conducted, a consumer identifier 604 associated with the consumer 102 involved in the transaction, and a transaction amount 510 or other transaction data.

The processing unit 204 may then match location data entries 214 to transaction data entries 210 based on correspondence between the times 504 and the consumer identifiers 604, which may identify those consumers that visited the specific geographic location and did not transact, and those that did. In the example illustrated in FIG. 6, the processing unit 204 may identify and match three location data entries 214 to the transaction data entries 210, corresponding to visits and transactions involving consumers associated with consumer identifiers 0145, 0167, and 0178. The three matched location data entries 214 and transaction data entries 210 may thus be placed in a first subset, while the remaining four location data entries 214 may be placed in a second subset. The processing unit 204 may then calculate consumer metrics based on the data.

As illustrated in FIGS. 5 and 6, in some embodiments the times 504 for location data entries 214 and those transaction data entries 210 matched to them may vary. For example, in FIG. 6, the location data entry 214 for the consumer 102 associated with the identifier 0145 indicates that the consumer 102 visited the location at 1:01 PM, while the corresponding transaction data entry 210 indicates that the consumer 102 transacted at 1:06 PM. Such variance may occur due to the length of time it may take for a consumer 102 to initiate a payment transaction at the merchant 106 and how long it may take for the transaction to be processed. For example, a consumer 102 may browse a store for fifteen minutes before making a purchase.

The processing unit 204 may be configured to match location data entries 214 with transaction data entries 210 when times 504 are within a predetermined period of time of one another. In some instances, the predetermined period of time may vary based on one or more factors, such as an industry of the merchant 106 (e.g., a longer period for grocery stores, a shorter period for fast food restaurants, etc.), time of day, day of the week, season, the weather, the merchant 106, the consumer 102, and other factors as will be apparent to persons having skill in the relevant art.

### First Exemplary Method for Calculating Consumer Metrics

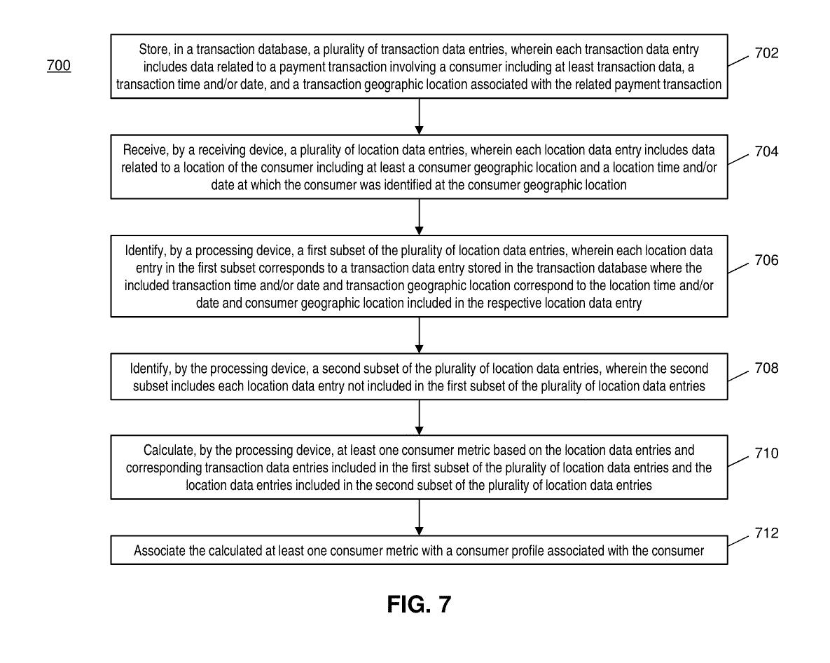

FIG. 7 illustrates a method 700 for the calculation of consumer metrics for a consumer 102 based on geolocation and transaction data.

In step 702, a plurality of transaction data entries (e.g., the transaction data entries 210) may be stored, in a transaction database (e.g., the transaction database 208), wherein each transaction data entry 210 includes data related to a payment transaction involving a consumer (e.g., the consumer 102) including at least transaction data, a transaction time and/or date, and a transaction geographic location associated with the related payment transaction. In one embodiment, the transaction data may include at least one of: a transaction amount, merchant data, product data, and a consumer identifier associated with the consumer 102.

In step 704, a plurality of location data entries (e.g., location data entries 214) may be received, by a receiving device (e.g., the receiving unit 202), wherein each location data entry 214 includes data related to a location of the consumer 102 including at least a consumer geographic location and a location time and/or date at which the consumer 102 was identified at the consumer geographic location. In some embodiments, the consumer geographic location may correspond to a merchant (e.g., the merchant 106). In a further embodiment, each location data entry 214 may further include a merchant category associated with the merchant 106. In some embodiments, the consumer geographic location in each location data entry 214 may be identified using a mobile communication device (e.g., the mobile computing device 104) associated with the consumer 102.

In step 706, a first subset of the plurality of location data entries may be identified, by a processing device (e.g., the processing unit 204), wherein each location data entry 214 in the first subset corresponds to a transaction data entry 210 stored in the transaction database 208 where the included transaction time and/or date and the transaction geographic location correspond to the location time and/or date and consumer geographic location included in the respective location data entry.

In step 708, a second subset of the plurality of location data entries may be identified, by the processing device 204, wherein the second subset includes each location data entry 214 not included in the first subset of the plurality of location data entries. In step 710, at least one consumer metric may be calculated, by the processing device 204, based on the location data entries 214 and the corresponding transaction data entries 210 included in the first subset of the plurality of location data entries and the location data entries 214 included in the second subset of the plurality of location data entries. In some embodiments, the at least one consumer metric may include at least one of: merchant preferences, location preferences, transaction behavior, location behavior, propensity to transact, and propensity to window shop.

In step 712, the calculated at least one consumer metric may be associated with a consumer profile (e.g., the consumer profile 218) associated with the consumer 102. In embodiments where each location data entry 214 may include a merchant category, the payment transaction related to each transaction data entry 210 of the plurality of transaction data entries may involve a specific merchant 106, and the merchant category included in each location data entry 214 may be a specific merchant category associated with the specific merchant 106. In a further embodiment, the method 700 may further include: receiving, by the receiving device 202, a request for data, wherein the request for data includes at least a merchant identifier associated with the specific merchant 106 and the at least one consumer metric; and transmitting, by a transmitting device (e.g., the transmitting unit 206), the calculated at least one consumer metric in response to the received request for data.

### Second Exemplary Method for Calculating Consumer Metrics

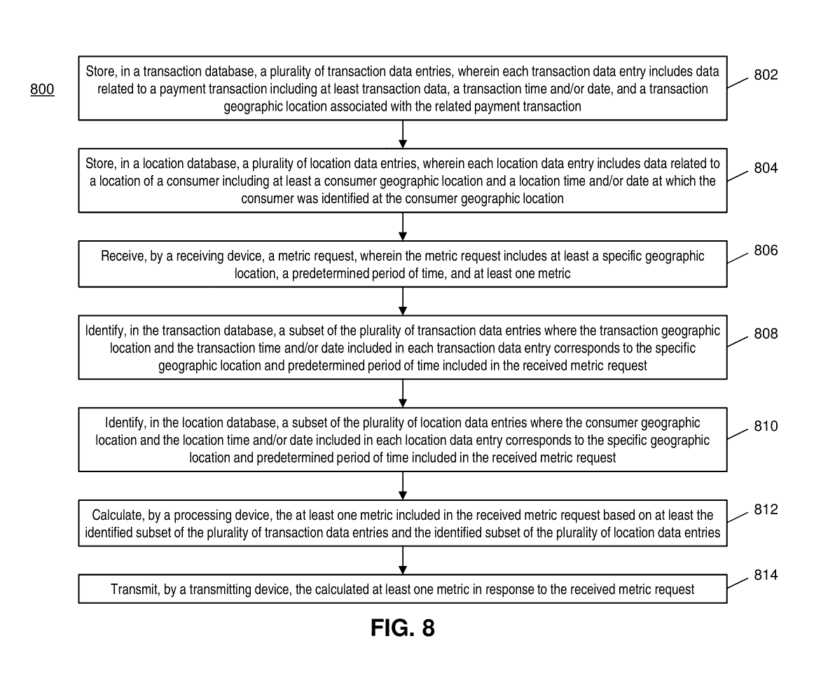

FIG. 8 illustrates a method 800 for the calculation of consumer metrics for a specific geographic location based on geolocation and transaction data.

In step 802, a plurality of transaction data entries (e.g., transaction data entries 210) may be stored, in a transaction database (e.g., the transaction database 208), wherein each transaction data entry 210 includes data related to a payment transaction including at least transaction data, a transaction time and/or date, and a transaction geographic location associated with the related payment transaction. In one embodiment, the transaction data may include at least one of: a transaction amount, merchant data, product data, and a consumer identifier.

In step 804, a plurality of location data entries (e.g., the location data entries 214) may be stored, in a location database (e.g., the location database 212), wherein each location data entry includes data related to a location of a consumer (e.g., the consumer 102) including at least a consumer geographic location and a location time and/or date at which the consumer 102 was identified at the consumer geographic location. In one embodiment, the consumer geographic location included in each location data entry may be identified using a mobile communication device (e.g., the mobile computing device 104) associated with the related consumer 102.

In step 806, a metric request may be received, by a receiving device (e.g., the receiving unit 202), wherein the metric request includes at least a specific geographic location, a predetermined period of time, and at least one metric. In one embodiment, the at least one metric may include at least one of: a turnaround rate, transaction frequency, visitor frequency, visitor statistics, and transaction statistics.

In step 808, a subset of the plurality of transaction data entries may be identified, in the transaction database 208, where the transaction geographic location and the transaction time and/or date included in each transaction data entry 210 corresponds to the specific geographic location and predetermined period of time included in the received metric request. In step 810, a subset of the plurality of location data entries may be identified, in the location database 212, where the consumer geographic location and the location time and/or date included in each location data entry 214 corresponds to the specific geographic location and predetermined period of time included in the received metric request.

In step 812, the at least one metric included in the received metric request may be calculated, by a processing device (e.g., the processing unit 204), based on at least the identified subset of the plurality of transaction data entries and the identified subset of the plurality of location data entries. In step 814, the calculated at least one metric may be transmitted, by a transmitting device (e.g., the transmitting unit 206), in response to the received metric request.

### Computer System Architecture

FIG. 9 illustrates a computer system 900 in which embodiments of the present disclosure, or portions thereof, may be implemented as computer-readable code. For example, the processing server 110 of FIG. 1 may be implemented in the computer system 900 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3, 4, 7, and 8.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 918, a removable storage unit 922, and a hard disk installed in hard disk drive 912.

Various embodiments of the present disclosure are described in terms of this example computer system 900. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 904 may be a special purpose or a general purpose processor device. The processor device 904 may be connected to a communications infrastructure 906, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 900 may also include a main memory 908 (e.g., random access memory, read-only memory, etc.), and may also include a secondary memory 910. The secondary memory 910 may include the hard disk drive 912 and a removable storage drive 914, such as a floppy disk drive, a magnetic tape drive, an optical disk drive, a flash memory, etc.

The removable storage drive 914 may read from and/or write to the removable storage unit 918 in a well-known manner. The removable storage unit 918 may include a removable storage media that may be read by and written to by the removable storage drive 914. For example, if the removable storage drive 914 is a floppy disk drive or universal serial port, the removable storage unit 918 may be a floppy disk or portable flash drive, respectively. In one embodiment, the removable storage unit 918 may be non-transitory computer readable recording media.

In some embodiments, the secondary memory 910 may include alternative means for allowing computer programs or other instructions to be loaded into the computer system 900, for example, the removable storage unit 922 and an interface 920. Examples of such means may include a program cartridge and cartridge interface (e.g., as found in video game systems), a removable memory chip (e.g., EEPROM, PROM, etc.) and associated socket, and other removable storage units 922 and interfaces 920 as will be apparent to persons having skill in the relevant art.

Data stored in the computer system 900 (e.g., in the main memory 908 and/or the secondary memory 910) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 900 may also include a communications interface 924. The communications interface 924 may be configured to allow software and data to be transferred between the computer system 900 and external devices. Exemplary communications interfaces 924 may include a modem, a network interface (e.g., an Ethernet card), a communications port, a PCMCIA slot and card, etc. Software and data transferred via the communications interface 924 may be in the form of signals, which may be electronic, electromagnetic, optical, or other signals as will be apparent to persons having skill in the relevant art. The signals may travel via a communications path 926, which may be configured to carry the signals and may be implemented using wire, cable, fiber optics, a phone line, a cellular phone link, a radio frequency link, etc.

Computer program medium and computer usable medium may refer to memories, such as the main memory 908 and secondary memory 910, which may be memory semiconductors (e.g., DRAMs, etc.). These computer program products may be means for providing software to the computer system 900. Computer programs (e.g., computer control logic) may be stored in the main memory 908 and/or the secondary memory 910. Computer programs may also be received via the communications interface 924. Such computer programs, when executed, may enable computer system 900 to implement the present methods as discussed herein. In particular, the computer programs, when executed, may enable processor device 904 to implement the methods illustrated by FIGS. 3, 4, 7, and 8, as discussed herein. Accordingly, such computer programs may represent controllers of the computer system 900. Where the present disclosure is implemented using software, the software may be stored in a computer program product and loaded into the computer system 900 using the removable storage drive 914, interface 920, and hard disk drive 912, or communications interface 924.

Techniques consistent with the present disclosure provide, among other features, systems and methods for calculating consumer metrics based on geolocation and transaction data. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for calculating consumer metrics, comprising:
storing, in a transaction database, a plurality of transaction data entries, wherein each transaction data entry includes data related to a payment transaction involving a consumer including at least transaction data, a transaction time and/or date, and a transaction geographic location associated with the related payment transaction;
receiving, by a receiving device, a plurality of location data entries, wherein each location data entry includes data related to a location of the consumer including at least a consumer geographic location and a location time and/or date at which the consumer was identified at the consumer geographic location;
identifying, by a processing device, a first subset of the plurality of location data entries, wherein each location data entry in the first subset corresponds to a transaction data entry stored in the transaction database where the included transaction time and/or date and transaction geographic location correspond to the location time and/or date and consumer geographic location included in the respective location data entry;
identifying, by the processing device, a second subset of the plurality of location data entries, wherein the second subset includes each location data entry not included in the first subset of the plurality of location data entries;
calculating, by the processing device, at least one consumer metric based on the location data entries and corresponding transaction data entries included in the first subset of the plurality of location data entries and the location data entries included in the second subset of the plurality of location data entries; and
associating the calculated at least one consumer metric with a consumer profile associated with the consumer.

2. The method of claim 1, wherein the at least one consumer metric includes at least one of: merchant preferences, location preferences, transaction behavior, location behavior, propensity to transact, and propensity to window shop.

3. The method of claim 1, wherein the consumer geographic location included in each location data entry corresponds to a merchant.

4. The method of claim 3, wherein each location data entry further includes a merchant category associated with the merchant corresponding to the included consumer geographic location.

5. The method of claim 4, wherein
the payment transaction related to each transaction data entry of the plurality of transaction data entries involves a specific merchant, and
the merchant category included in each location data entry is a specific merchant category associated with the specific merchant.

6. The method of claim 5, further comprising:
receiving, by the receiving device, a request for data, wherein the request for data includes at least a merchant identifier associated with the specific merchant and the at least one consumer metric; and
transmitting, by a transmitting device, the calculated at least one consumer metric in response to the received request for data.

7. The method of claim 1, wherein the transaction data includes at least one of: a transaction amount, merchant data, product data, and a consumer identifier associated with the consumer.

8. The method of claim 1, wherein the consumer geographic location included in each location data entry is identified using a mobile communication device associated with the consumer.

9. A method for calculating consumer metrics, comprising:
storing, in a transaction database, a plurality of transaction data entries, wherein each transaction data entry includes data related to a payment transaction including at least transaction data, a transaction time and/or date, and a transaction geographic location associated with the related payment transaction;
storing, in a location database, a plurality of location data entries, wherein each location data entry includes data related to a location of a consumer including at least a consumer geographic location and a location time and/or date at which the consumer was identified at the consumer geographic location;
receiving, by a receiving device, a metric request, wherein the metric request includes at least a specific geographic location, a predetermined period of time, and at least one metric;
identifying, in the transaction database, a subset of the plurality of transaction data entries where the transaction geographic location and the transaction time and/or date included in each transaction data entry corresponds to the specific geographic location and predetermined period of time included in the received metric request;
identifying, in the location database, a subset of the plurality of location data entries where the consumer geographic location and the location time and/or date included in each location data entry corresponds to the specific geographic location and predetermined period of time included in the received metric request;
calculating, by a processing device, the at least one metric included in the received metric request based on at least the identified subset of the plurality of transaction data entries and the identified subset of the plurality of location data entries; and
transmitting, by a transmitting device, the calculated at least one metric in response to the received metric request.

10. The method of claim 9, wherein the transaction data includes at least one of: a transaction amount, merchant data, product data, and a consumer identifier.

11. The method of claim 9, wherein the at least one metric includes at least one of: a turnaround rate, transaction frequency, visitor frequency, visitor statistics, and transaction statistics.

12. The method of claim 9, wherein the consumer geographic location included in each location data entry is identified using a mobile communication device associated with the related consumer.

13. A system for calculating consumer metrics, comprising:
a transaction database configured to store a plurality of transaction data entries, wherein each transaction data entry includes data related to a payment transaction involving a consumer including at least transaction data, a transaction time and/or date, and a transaction geographic location associated with the related payment transaction;
a receiving device configured to receive a plurality of location data entries, wherein each location data entry includes data related to a location of the consumer including at least a consumer geographic location and a location time and/or date at which the consumer was identified at the consumer geographic location; and
a processing device configured to
identify a first subset of the plurality of location data entries, wherein each location data entry in the first subset corresponds to a transaction data entry stored in the transaction database where the included transaction time and/or date and transaction geographic location correspond to the location time and/or date and consumer geographic location included in the respective location data entry,
identify a second subset of the plurality of location data entries, wherein the second subset includes each location data entry not included in the first subset of the plurality of location data entries,
calculate at least one consumer metric based on the location data entries and corresponding transaction data entries included in the first subset of the plurality of location data entries and the location data entries included in the second subset of the plurality of location data entries, and
associate the calculated at least one consumer metric with a consumer profile associated with the consumer.

14. The system of claim 13, wherein the at least one consumer metric includes at least one of: merchant preferences, location preferences, transaction behavior, location behavior, propensity to transact, and propensity to window shop.

15. The system of claim 13, wherein the consumer geographic location included in each location data entry corresponds to a merchant.

16. The system of claim 15, wherein each location data entry further includes a merchant category associated with the merchant corresponding to the included consumer geographic location.

17. The system of claim 16, wherein
the payment transaction related to each transaction data entry of the plurality of transaction data entries involves a specific merchant, and
the merchant category included in each location data entry is a specific merchant category associated with the specific merchant.

18. The system of claim 17, further comprising:
a transmitting device, wherein
the receiving device is further configured to receive a request for data, wherein the request for data includes at least a merchant identifier associated with the specific merchant and the at least one consumer metric, and
the transmitting device is configured to transmit the calculated at least one consumer metric in response to the received request for data.

19. The system of claim 13, wherein the transaction data includes at least one of: a transaction amount, merchant data, product data, and a consumer identifier associated with the consumer.

20. The system of claim 13, wherein the consumer geographic location included in each location data entry is identified using a mobile communication device associated with the consumer.

21. A system for calculating consumer metrics, comprising:
a transaction database configured to store a plurality of transaction data entries, wherein each transaction data entry includes data related to a payment transaction including at least transaction data, a transaction time and/or date, and a transaction geographic location associated with the related payment transaction;
a location database configured to store a plurality of location data entries, wherein each location data entry includes data related to a location of a consumer including at least a consumer geographic location and a location time and/or date at which the consumer was identified at the consumer geographic location;
a receiving device configured to receive a metric request, wherein the metric request includes at least a specific geographic location, a predetermined period of time, and at least one metric;
a processing device configured to
identify, in the transaction database, a subset of the plurality of transaction data entries where the transaction geographic location and the transaction time and/or date included in each transaction data entry corresponds to the specific geographic location and predetermined period of time included in the received metric request,
identify, in the location database, a subset of the plurality of location data entries where the consumer geographic location and the location time and/or date included in each location data entry corresponds to the specific geographic location and predetermined period of time included in the received metric request, and
calculate the at least one metric included in the received metric request based on at least the identified subset of the plurality of transaction data entries and the identified subset of the plurality of location data entries; and
a transmitting device configured to transmit the calculated at least one metric in response to the received metric request.

22. The system of claim 21, wherein the transaction data includes at least one of: a transaction amount, merchant data, product data, and a consumer identifier.

23. The system of claim 21, wherein the at least one metric includes at least one of: a turnaround rate, transaction frequency, visitor frequency, visitor statistics, and transaction statistics.

24. The system of claim 21, wherein the consumer geographic location included in each location data entry is identified using a mobile communication device associated with the related consumer.
